(19) United States
(12) Patent Application Publication
(10) Pub. No.: US 2023/0019242 A1
(43) Pub. Date: Jan. 19, 2023

(54) SYSTEM FOR MOUNTING ROOF TILES

(71) Applicant: Arka Energy Inc., Union City, CA (US)

(72) Inventors: MAHADEVA PRASAD H S, Chamarajanagar (IN); MARATH PRAKASH, Bangalore (IN)

(21) Appl. No.: 17/865,635

(22) Filed: Jul. 15, 2022

(30) Foreign Application Priority Data
Jul. 15, 2021 (IN) 202111031928

(51) Int. Cl. H02S 20/25; E04D 13/00; E04D 1/30

(52) U.S. Cl. CPC H02S 20/25; E04D 13/00; E04D 1/30

(57) ABSTRACT

A system for mounting roof tiles, such as solar tiles 108, is disclosed. The system includes a plurality of base mounting sections 200, a plurality of pin joint 102 and a plurality of overhang sections 104. The base mounting sections are fixed to deck 302 horizontally in spaced disposition parallel to a deck ridge 304, and the pin joints 102 and the overhang sections 104 are fixed to two proximal and distal sides of tiles 108 by adhesives. The tiles 108 are removably installed over a pair of adjacent base mounting sections 200 with the overhang section 104 fastened to the proximal base mounting section 200 and the pin joints 102 fastened to the distal base mounting section 200. After installation, the overhang section 104 overlaps with the tiles 108 of adjacent row on the proximal side thereby preventing ingress of water.

### CROSS-REFERENCE TO RELATED APPLICATIONS

This application claims priority to India Application No. 202111031928, filed Jul. 15, 2021, the disclosure of which is incorporated herein by reference.

### TECHNICAL FIELD

The present disclosure relates generally to systems for tile mounting. More specifically, it relates to a system for installing solar tiles and/or shingles on roof tops.

### BACKGROUND

Background description includes information that may be useful in understanding the present invention. It is not an admission that any of the information provided herein is prior art or relevant to the presently claimed invention, or that any publication specifically or implicitly referenced is prior art.

Conventional systems of installing solar power on residential rooftops generally involve use of elevated steel structures or sections that show a Photovoltaic system as a separate entity and not part of the roof. The module size, shape and colour may not match with that of the roof, which leads to poor aesthetics. In order to improve aesthetics, the modules need to be installed as part of the roof and should look similar to the roof tiles, shingles, and the like.

Furthermore, in conventional systems for solar tiles mounting, it is difficult to replace individual panels and other modules which are generally arranged in a grid type assembly. Prior-art systems may use snap fitting or snap locking mechanism for attaching tiles; however, such systems provide less flexibility for installing and/or removing tiles.

Therefore, there is a need to provide an aesthetically designed solar power system in which modules can be installed as part of the roof and which can obviate aforementioned limitations in the art.

### OBJECTS OF THE INVENTION

A general object of the present disclosure is to provide a solar tile mounting assembly that obviates the above mentioned limitations of conventional systems for mounting tiles.

An object of the present disclosure is to provide a system for mounting solar tiles or shingles on a residential roof deck in an aesthetic manner.

An object of the present disclosure is to provide a tile mounting system having an aesthetic appeal similar to a conventional tile or shingled roof with added benefits of solar power production and protection of the property from external elements.

Another object of the present disclosure is to make the solar tile mounting assembly waterproof.

Another object of the present disclosure is to improve performance of the installed solar tiles by providing an elevated structure and vents to facilitate convective cooling at back side of the tiles for proper ventilation.

Another object of the present disclosure is to provide a solar tile mounting assembly having better cable routing and power device attachment.

Another object of the present disclosure is to provide a solar tile mounting system having improved fire rating for facilitating fire prevention.

Yet another object of the present disclosure is to provide a solar tile mounting assembly which enables easy install and un-install of tiles for repairs and replacement.

### SUMMARY

Aspects of the present disclosure relate to mounting of tiles at rooftop. In particular, the present disclosure provides a system for mounting solar tiles that overcomes drawbacks of conventional systems in relation with ease of installation and removal of the tiles for repair and replacement, besides ensuring leakproof installation.

In an aspect, the proposed system for installation of tiles includes a plurality of base mounting sections, a plurality of pin joint and a plurality of overhang sections. The plurality of base mounting sections are fixed to a deck horizontally in spaced disposition parallel to a deck ridge. The pin joint are of stepped cross section with a thicker portion and a thinner portion. The pin joints are affixed to a side of the solar tiles that is distal to the deck ridge such that an upper surface of the thinner portion of the pin joints is affixed to a lower surface of the tile.

The overhang sections have Z-shaped cross section with a raised portion and a lower portion. One overhang section is fixed to a proximal side of each of the tiles such that the tile rests on an upper surface of the lower portion of the overhang section.

The solar tiles, along with the pin joints and the overhang section fixed thereto, are removably installed over a pair of adjacent base mounting sections with the overhang section fastened to the proximal base mounting section and the pin joints fastened to the distal base mounting section.

The pin joints may be configured such that when the pin joint is fixed to the tile, an upper surface of the thicker portion is coplanar with the upper surface of the tile. The overhang sections may be configured such that when the overhang section is fixed to the tile, an upper surface of the raised portion is coplanar with the upper surface of the tile. Accordingly, the raised portion of the overhang section overlaps with the distal side of the adjacent solar tiles on the proximal side thereby preventing ingress of water.

Each of the plurality of base mounting sections can include a plurality of pin insertion blocks fixed on an upper side of the base mounting sections. The pin joints and the overhang sections may be fastened to the corresponding base mounting sections through the pin insertion blocks.

The pin joints may include a pin hole oriented parallel to the deck ridge for fastening the pin joints to the corresponding base mounting section by a pin through a corresponding hole in the pin insertion blocks.

The overhang sections may include a plurality of vertical holes for fastening the overhang sections to the corresponding base mounting section by a plurality of screws or bolts through corresponding vertical holes in each of the plurality of the pin insertion blocks.

The overhang sections and the pin joints may be fixed to the solar tiles using any one or more of a structural adhesive, and a high strength adhesive tape. The adhesive, and the adhesive tape may be embedded within a laminate of the solar tiles.

The base mounting sections may include at least one air vent to allow ventilation in the space between the deck, the adjacent base mounting sections and the tiles mounted thereon, and wherein the ventilation prevents overheating of the tiles.

The plurality of base mounting sections may include at least one of a plurality of pre-drilled bolting holes, a plurality of cable holding clips, or a plurality of clips for attaching a device.

The plurality of base sections may be made of any or a combination of one or more metals or one or more fire-retardant materials.

At least one of the plurality of tiles may be sealed by applying one or more materials on at least a portion of the at least one of the of the plurality of tiles.

The plurality of base mounting sections may be attached to the deck using any or a combination of bolting, one or more self-tapping screws, or application of structural adhesive or adhesive tape.

Any or a combination of underlayment or one or more construction boards may be used to make the system waterproof and fire resistant.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure. The diagrams are for illustration only, which thus is not a limitation of the present disclosure.

FIGS. 1A and 1B illustrate exemplary perspective views of a pin joint section and an overhang section of the disclosed system for mounting tiles, in accordance with embodiments of the present disclosure.

FIG. 1C illustrates an exemplary perspective view showing the pin joints and the overhang section fixed to opposite sides of a tile, in accordance with embodiments of the present disclosure.

FIGS. 2A and 2B illustrate exemplary perspective views of a base mounting section of the disclosed system, from a front side and back side respectively, in accordance with embodiments of the present disclosure.

FIGS. 3A-3D illustrate different stages of tile installation using the disclosed tile mounting system, in accordance with embodiments of the present disclosure.

FIGS. 4A and 4B respectively illustrate exemplary side view and sectional view of the mounted tiles using the disclosed system, in accordance with embodiments of the present disclosure.

### DETAILED DESCRIPTION

In the following description, numerous specific details are set forth in order to provide a thorough understanding of embodiments of the present invention. It will be apparent to one skilled in the art that embodiments of the present invention may be practiced without some of these specific details.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all groups used in the appended claims.

Exemplary embodiments will now be described more fully hereinafter with reference to the accompanying drawings, in which exemplary embodiments are shown. This invention may, however, be embodied in many different forms and should not be construed as limited to the embodiments set forth herein. These embodiments are provided so that this disclosure will be thorough and complete and will fully convey the scope of the invention to those of ordinary skill in the art. Moreover, all statements herein reciting embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Embodiments explained herein relate to a tile mounting system. More specifically, it relates to a system for installing roof tiles, such as but not limited to solar tiles, on roof tops, such as a roof deck. In an embodiment, the disclosed mounting system is based on two or more distinct sections made of metal and/or suitable fire-retardant material that are designed to be attached to two opposite sides, such as a side proximal to a ridge of the deck (hereinafter referred to as deck ridge) and the opposite side (hereinafter referred to as proximal side and distal side), of the tiles by suitable methods like adhesion, embedding, etc. The sections include features that are used for quickly and removeably attaching the tile onto one or more base mounting sections that are fixed to the deck in spaced parallel disposition, parallel to the deck ridge.

It is to be appreciated that while the embodiments herein have been described with reference to installation of solar tiles, the disclosed system can be used for installing any other tiles or shingles, and all such applications are well within the scope of the present application without any limitations whatsoever.

In an embodiment, the proposed system helps in installing or mounting solar roof tiles and any other roof tiles or shingles to the roof deck in a very easy manner while maintaining the normal properties of a roof such as protecting the house from wind, rain, snow and other external conditions.

In another embodiment, the proposed system may be a solar tile mounting assembly that can be used to install solar tiles or shingles on a roof deck in an aesthetic manner. The proposed system may have additional features such as making the assembly waterproof, improving performance of the solar tiles by providing suitable ventilation, attaching one or more devices such as cabling and power conversion devices, capability of preventing fires, and supporting easy installation and/or un-installation of one or more components for repair and/or replacement.

In another embodiment, the proposed system may support assembly of one or more solar tiles directly on the roof deck without use of conventional tiles and shingles using the one or more designed sections and features in-built in the one or more designed sections. The proposed tile mounting system may provide an aesthetic appeal similar to a conventional tile or shingled roof with added benefits of solar power production and protection of the property from external elements.

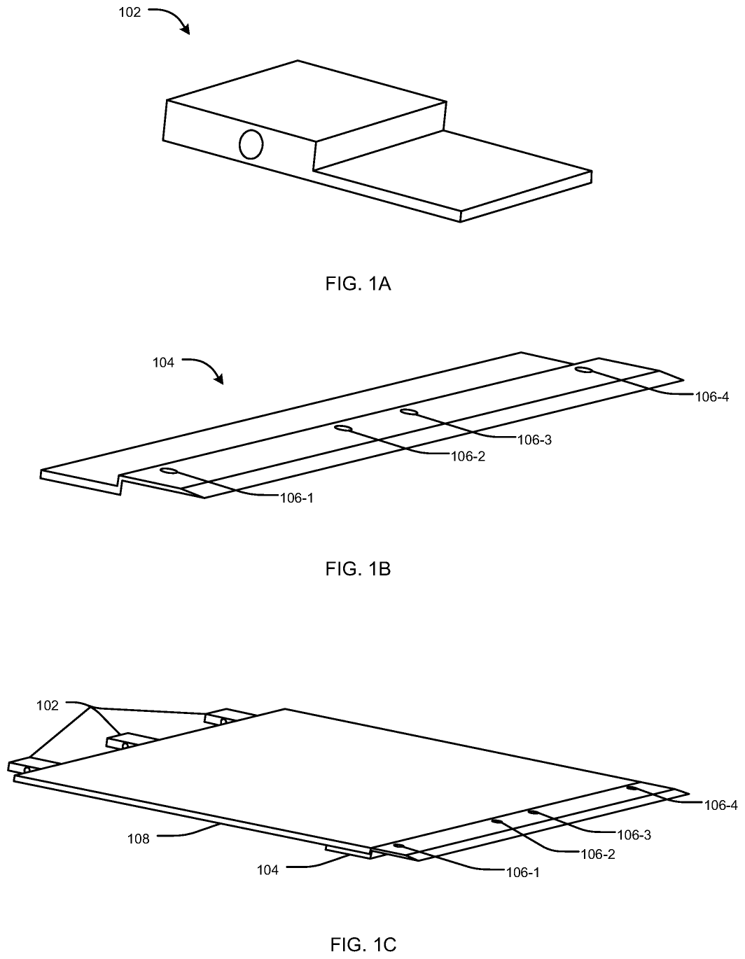

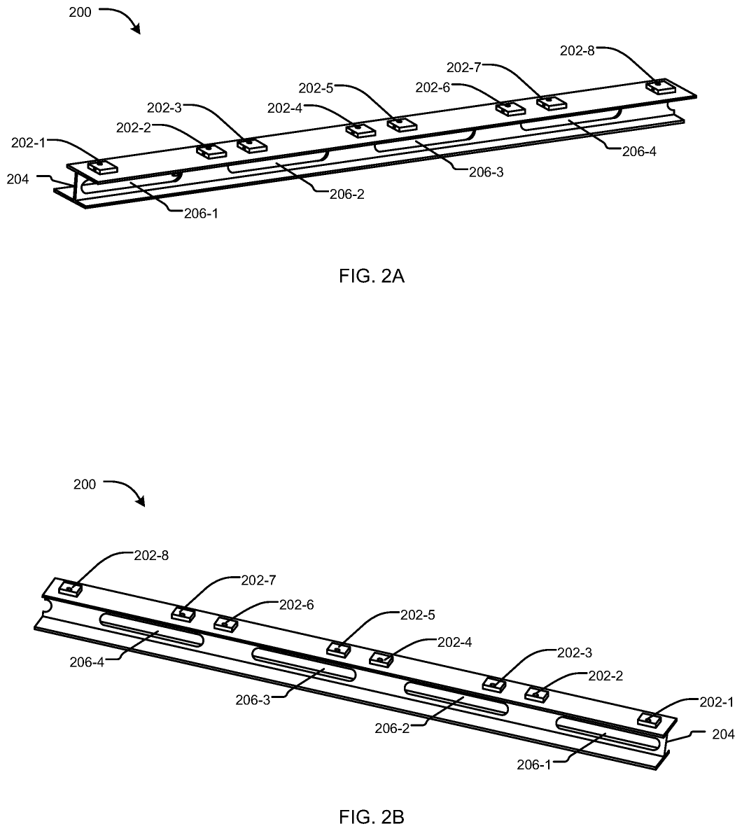

Referring to FIGS. 1A-1B, where exemplary perspective views of a pin joint section 102 (also referred simply as pin joint 102 and the two terms used interchangeably hereinafter) and an overhang section 104 have been disclosed, as shown in FIG. 1A, the pin joint 102 can have a stepped section having a thinner portion 112 and a thicker portion 110. It can also include a cross hole such as hole 114 located on the thicker portion 110. The cross hole 114 can be used for fastening the pin joint 102 to a base mounting section using a pin, as would be explained in the subsequent paragraphs. The overhang section 104 can have a Z-shaped cross section can have a raised portion 116 and a lower portion 118, and can include a plurality of vertically oriented holes, such as holes 106-1, 106-2, . . . etc, (collectively holes 106), which can be used to fasten the overhang sections 104 to the base mounting section using pins, as would be explained in the subsequent paragraphs.

FIG. 1C shows a tile 108 fixed with the pin joints 102 and the overhang section 104. Specifically, two opposite sides of the tile 108 can respectively be fixed with the thinner portions 112 of the pin joint sections 102 and the lower portion 118 of the overhang section, as shown in FIG. 1C. The tile 108 as shown in FIG. 1C is ready for removably mounting on a pair of adjacent base mounting sections 200, as shown in the succeeding figures.

In an embodiment, the pin joint sections 102 and the overhang section 104 may be fixed to the tile 108 by using structural adhesives or adhesive tapes, embedded within the tile 108 as laminates.

The pin joint section 102 and the overhang section 104 may be made of any or a combination of one or more metals or one or more suitable fire-retardant materials.

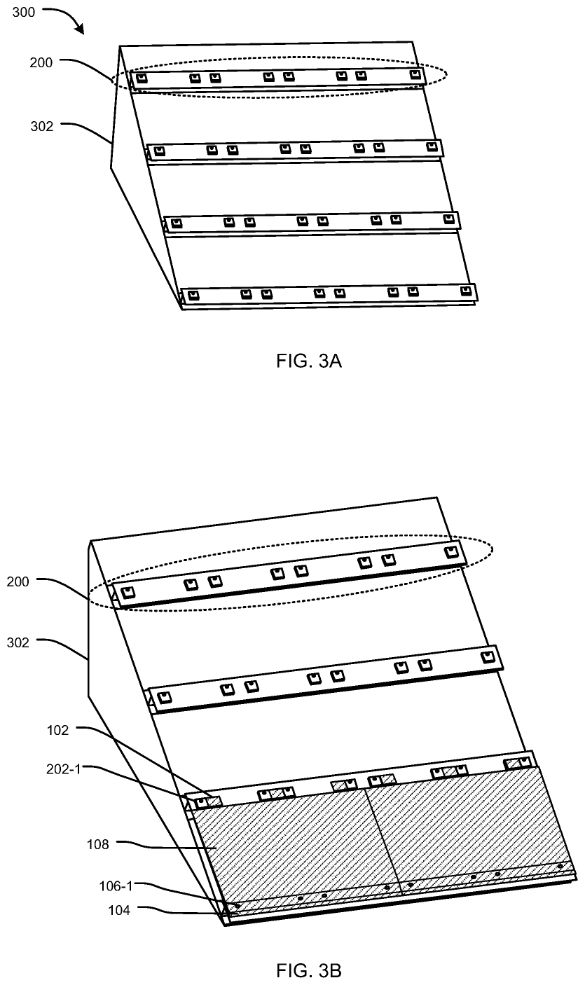

FIGS. 2A and 2B show perspective views of a base mounting section 200 of the disclosed system, from a front side and back side respectively. As shown, the base mounting section 200 may include a plurality of pin insertion blocks 202-1, 202-2, 202-3, 202-4, 202-5, 202-6, 202-7, and 202-8 (also referred individually as insertion block 202 or block 202 and collectively as insertion blocks 202 or blocks 202) and a plurality of air vents 206-1, 206-2, 206-3, and 206-4 (also referred individually as air vent 206 or vent 206 and collectively as air vents 206 or vents 206). Each of the pin insertion blocks 202 can include a vertical hole, such as vertical holes 208-1. 2-8-2, . . . etc, (collectively vertical hole 208) and a cross hole, such as cross holes 210-1, 210-2, . . . etc. (collectively cross holes 210) to respectively fasten the overhang section 104 and the pin joint sections 102 through respective hardware, such as pins, screws or bolts (not shown here).

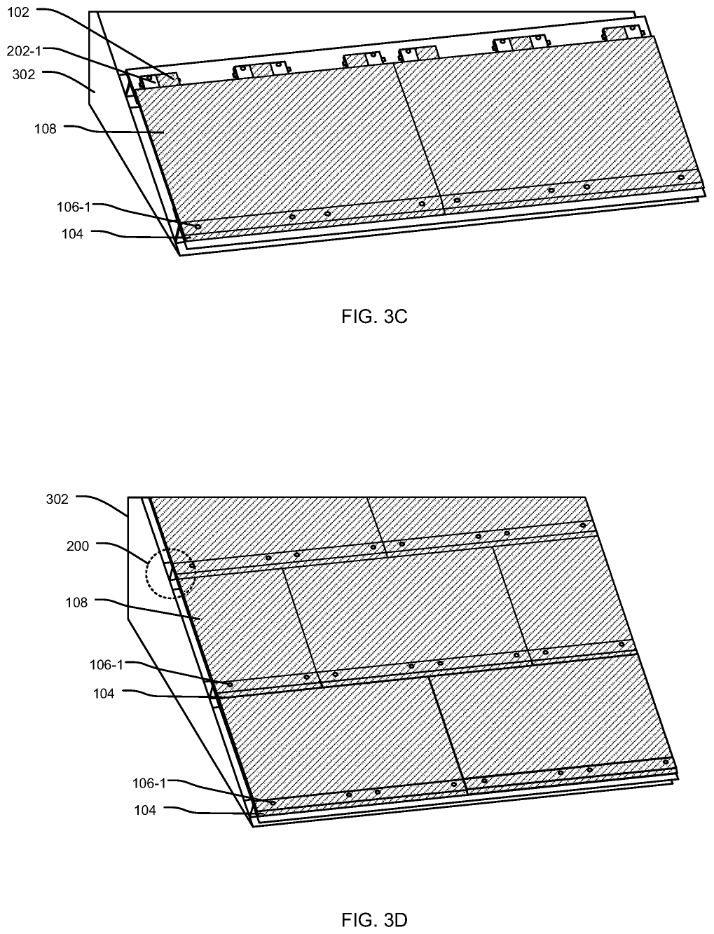

In an embodiment, the base mounting section 200 may also include one or more pre-drilled bolting holes, one or more cable holding clips, and/or one or more clips for attaching one or more devices (e.g., power conversion device). The one or more pre-drilled bolting holes (not shown) of the base mounting section 200 may be used to fasten the base mounting section 200 to a roof deck 302 (refer to FIGS. 3A and 3B). The base mounting section 200 may be made of metal and/or suitable fire-retardant material.

FIGS. 3A-3D show different stages of installation of tiles, wherein, as shown in FIG. 3A, a plurality of base mounting sections 200 can be fixed to a deck 302 horizontally in spaced disposition parallel to a deck ridge 304. In a next stage a first row of tiles 108 affixed with the pin joints 102 and the overhang sections 104 can be positioned over the pair of adjacent base mounting section 200 that are closest to the deck ridge 304, and the associated overhang sections 104 and the pin joints can be fastened to the corresponding base mounting section 200 using the respective hardware.

In the next stage of the tile mounting using the disclosed system, a second row of tiles 108 affixed with the pin joints 102 and the overhang sections 104 can be positioned over the next pair of adjacent base mounting sections 200, i.e. the second and third base mounting sections 200 from the deck ridge 304, and the associated overhang sections 104 and the pin joints 102 can be fastened to the corresponding base mounting section 200 using the respective hardware.

In an aspect, the pin joint section 102 and the overhang section 104 are dimensioned such that when the next row of tiles 108 is mounted, the raised portion 116 of the overhang section 104 overlaps at least a portion of the pin joint section 102 as well as the tile 108 of the adjacent row of tiles 108 towards the deck ridge 304. This prevents water leakage through a joint be tween the adjacently fixed tiles 108. As shown in FIG. 3D, subsequent rows of the tiles 108 can be installed in similar manner.

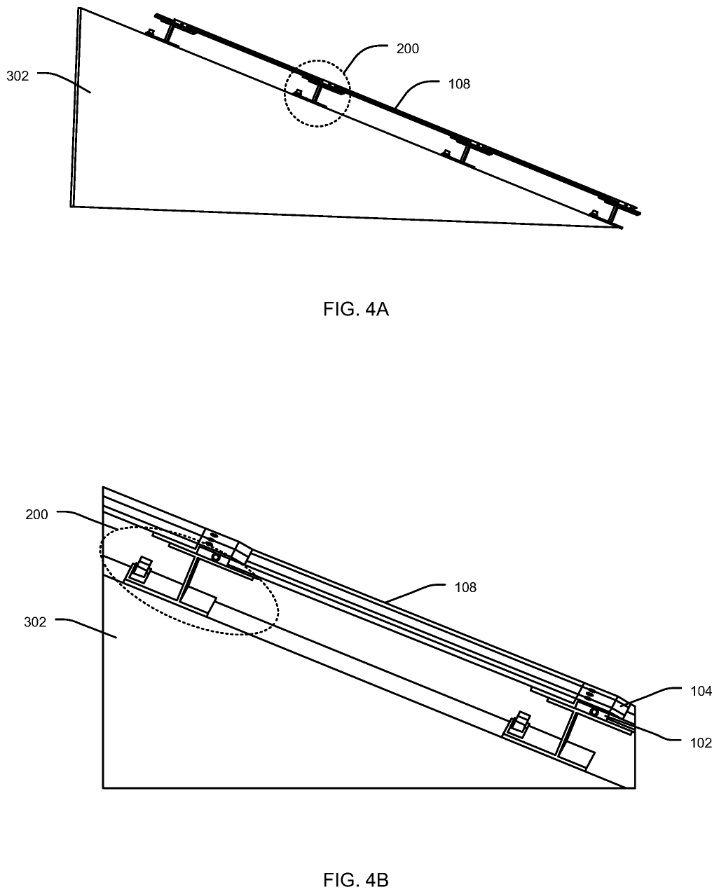

FIGS. 4A and 4B show a side view and a sectional view of the installed tiles 108 using the disclosed system 400 comprising a plurality of base mounting sections 200, a plurality of pin joints 102 and a plurality of overhang sections 104. The sectional view of FIG. 4B also shows the overlap of the overhang section 104 with the pin joints 102 and tile 108 of the adjacent row on the side proximal to the deck ridge 304.

In an embodiment, the proposed system may include additional sealing by using suitable materials like silicone rubber, EPDM, neoprene rubber, and the like on one or more edges of a tile (e.g., side edges) for good waterproofing. The proposed system may also support underlayment and gypsum board over the wood decking for better fire rating for assembly. Further, the proposed mounting mechanism may allow easy removal or replacement of one or more tiles whenever there is a need. The bolts or screws of the overhang sections 104 of a solar tile 108 and another tile in the above row may need to be removed by suitable tools to allow the solar tile 108 to be lifted. Such removal of the bolts or screws may allow access to the pin joints sections 102 of the solar tile 108. Then, pins and the locking nuts can then be removed from the pin joints sections 102 by suitable tools to allow the solar tile 108 to be removed from the assembly.

In another embodiment, two or more distinct sections made of metal and/or suitable fire-retardant material may be designed to be attached onto a rear side of a tile 108 by suitable methods like adhesion, embedding, etc. The sections may have features that can be used for attaching the tile onto one or more base mounting sections 200. Additional structural attachment entities like adhesive pastes, tapes may be added onto the sections as per the requirement.

In another embodiment, one or more base mounting sections 200 may be made of metal and/or suitable fire-retardant material. The one or more sections 200 may have features such as pin insertion blocks, bolting holes, air vents, cable holding clips and clips for attaching power conversion device. The one or more base mounting sections 200 may be designed to be attached to a roof wooden deck 302 using one or more suitable methods like bolting, using self-tapping screws, using structural adhesives, adhesive tapes, and the like.

In an embodiment, the proposed tile mounting system may be easy to install because of use of less number of parts, thereby lowering time and cost of installation. The proposed system may have improved performance due to the elevated structure and vents to facilitate convective cooling at rear side of the tiles. The proposed system may have good aesthetics as it can take care of roof undulations. The proposed system may have better cable routing and power device attachment as one or more components may have these options or features in-built. In the proposed tile mounting system, fire rating may also be improved as one or more components may be made of metal or fire retardant materials and elevated from the roof deck. The proposed system may facilitate a simple, easy, and/or on-demand uninstallation process for uninstalling one or more components (e.g., tiles, sections) in order to effectively carry out repair or replacement.

In another embodiment, the proposed system may have one or more base sections with one or more blocks and one or more pre-drilled holes and corresponding assembling components which may be structurally adhered to the tiles. The one or more base sections may be arranged horizontally parallel to roof ridge. In the proposed system, individual tiles can be assembled and disassembled easily. Offsets between tile rows may be possible to improve the aesthetics as well as to provide waterproofing. Pin joint connection in the individual tiles can help in disassembling the tile easily without fully removing the adjacent tiles. Further, the one or more base sections may have one or more options for tile assembly, for example, by pin joint(s) and/or bolting. The proposed system may be configured to take care of the tolerances and slight mismatches in tile and base section dimensions.

In another embodiment, the proposed system may have one or more base sections which may be arranged like a rail with one or more blocks and one or more pre drilled holes and corresponding assembling components which may be structurally adhered to one or more tiles.

In yet another embodiment, a pin joint section may be coupled at a top end, i.e. a distal side. of a solar tile and an overhang section may be coupled at the bottom end, i.e. a proximal side, of the solar tile. The pin joint and overhang sections may be fixed to the solar tile by any or a combination of adhesives, adhesive tapes, or embedded within the tile laminate. A set of mounting base frame may be configured with the roof deck in a parallel manner, where each of the set of mounting base frames may include a plurality of pin insertion blocks, one or more vent holes, and one or more holes for bolting or screwing the mounting base frame with the roof deck. When the solar tile, having the pin joint and overhang sections, is placed over at least one of the mounting base frames, the pin joint section and at least one of the plurality of pin insertion blocks may be fastened together, where the pin joint section and/or the overhang section may be fastened with the mounting base frame, for securing the solar tile to the roof, using one or more fastening mechanisms such as locking nuts.

Also, when the solar tiles are coupled in the upper row, the overhang section of the upper row tiles overlaps the pin joint section of the lower row tiles. Further, the pins and the locking nuts can be removed easily by suitable tools thus allowing the solar tiles to be detached from the roof easily.

Thus, it will be appreciated by those of ordinary skill in the art that the diagrams, schematics, illustrations, and the like represent conceptual views or processes illustrating systems and methods embodying this invention. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this invention. Those of ordinary skill in the art further understand that the exemplary hardware, software, processes, methods, and/or operating systems described herein are for illustrative purposes and, thus, are not intended to be limited to any particular named.

In the foregoing description, numerous details are set forth. It will be apparent, however, to one of ordinary skill in the art having the benefit of this disclosure, that the present invention may be practiced without these specific details. In some instances, well-known structures and devices are shown in block diagram form, rather than in detail, to avoid obscuring the present invention.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously. Within the context of this document terms “coupled to” and “coupled with” are also used euphemistically to mean “communicatively coupled with” over a network, where two or more devices are able to exchange data with each other over the network, possibly via one or more intermediary device.

### Advantages of the Invention

The present disclosure provides a solar tile mounting assembly which obviates the above mentioned limitations of conventional tile mounting systems.

The present disclosure provides a tile mounting assembly which supports installation of solar tiles or shingles on a residential roof deck in an aesthetic manner.

The present disclosure provides a tile mounting system having an aesthetic appeal similar to a conventional tile or shingled roof with added benefits of solar power production and protection of the property from external elements.

The present disclosure provides a tile mounting assembly having improve performance of the solar tiles by providing an elevated structure and vents to facilitate convective cooling at back side of the tiles for proper ventilation

The present disclosure provides a waterproof solar tile mounting assembly.

The present disclosure provides a solar tile mounting assembly which facilitates better cable routing and power device attachment.

The present disclosure provides a solar tile mounting system having improved fire rating for facilitating fire prevention.

The present disclosure provides a solar tile mounting assembly which supports easy install and un-install of tiles for repairs and replacement.

1. A system for mounting solar tiles, the system comprising:
a plurality of base mounting sections fixed to a deck horizontally in spaced disposition parallel to a deck ridge;
a plurality of pin joints having a stepped cross section with a thicker portion and a thinner portion, wherein the pin joints are affixed to a side of the solar tiles that is distal to the deck ridge such that an upper surface of the thinner portion of the pin joints is affixed to a lower surface of the solar tiles; and
a plurality of overhang sections having a Z-shaped cross section with a raised portion and a lower portion, wherein one overhang section is affixed to a proximal side of each of the solar tiles such that the solar tiles rest on an upper surface of the lower portion of the overhang section;
wherein the solar tiles are removably installed over a pair of adjacent base mounting sections with the overhang section fastened to the proximal base mounting section, and the pin joints fastened to the distal base mounting section.

2. The system as claimed in claim 1, wherein, when the pin joint is fixed to the solar tile, an upper surface of the thicker portion is coplanar with the upper surface of the solar tiles.

3. The system as claimed in claim 2, wherein, when the overhang section is fixed to the solar tiles, an upper surface of the raised portion is coplanar with the upper surface of the solar tiles.

4. The system as claimed in claim 3, wherein the raised portion of the plurality of overhang section overlaps with the distal side of the adjacent solar tiles on the proximal side.

5. The system as claimed in claim 1, wherein each of the plurality of base mounting sections comprises a plurality of pin insertion blocks fixed on an upper side of the plurality of base mounting sections, and wherein the plurality of pin joints and the plurality of overhang sections are fastened to the corresponding base mounting sections through the plurality of pin insertion blocks.

6. The system as claimed in claim 5, wherein the plurality of pin joints comprise a pin hole oriented parallel to the deck ridge for fastening the plurality of pin joints to the corresponding plurality of base mounting section by a pin through a corresponding hole in each of the plurality of pin insertion blocks.

7. The system as claimed in claim 5, wherein the plurality of overhang sections include a plurality of vertical holes for fastening the overhang sections to the corresponding plurality of base mounting section by a plurality of screws or bolts through a corresponding vertical hole in each of the plurality of the pin insertion blocks.

8. The system as claimed in claim 3, wherein the overhang sections and the plurality of pin joints are fixed to the solar tiles using an adhesive, an adhesive tape, or combinations thereof, wherein the adhesive, the adhesive tape, or combinations thereof, are embedded within a laminate of the solar tiles.

9. The system as claimed in claim 1, wherein the base mounting sections comprise at least one air vent to allow ventilation in the space between the deck, wherein the adjacent base mounting sections and the tiles mounted thereon, wherein the ventilation prevents overheating of the tiles.

10. The system as claimed in claim 1, wherein the plurality of base mounting sections comprise at least one of a plurality of pre-drilled bolting holes, a plurality of cable holding clips, or a plurality of clips for attaching a device.

11. The system as claimed in claim 1, wherein the plurality of base mounting sections are made of one or more metals, one or more fire-retardant materials, or combinations thereof.

12. The system as claimed in claim 1, wherein at least one of the solar tiles is sealed by applying one or more materials on at least a portion of the at least one of the solar tiles.

13. The system as claimed in claim 1, wherein the plurality of base mounting sections are attached to the deck using bolts, one or more self-tapping screws, structural adhesive, adhesive tape, or combinations thereof.

14. The system as claimed in claim 1, wherein any or a combination of underlayment or one or more construction boards is used to make the system waterproof and fire resistant.
